(19) United States
(12) Patent Application Publication
(10) Pub. No.: US 2026/0235345 A1
(43) Pub. Date: Aug. 13, 2026

(54) DOOR BODY DEVICE AND REFRIGERATION APPARATUS

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Huawei Zhang, Hefei (CN); Zhanwei Liu, Hefei (CN); Tianxiang Jia, Hefei (CN); Dalei Yin, Hefei (CN)

(21) Appl. No.: 19/161,243

(22) PCT Filed: Nov. 19, 2024
(86) PCT No.: PCT/CN2024/133018

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187603.7

(51) Int. Cl. F25D 23/02

(52) U.S. Cl. CPC F25D 23/028; F25D 2323/024; F25D 2400/18; F25D 2500/02

(57) ABSTRACT

The present application relates to the technical field of refrigeration apparatuses. Provided are a door body device and a refrigeration apparatus, the door body device comprising a refrigerator door, a cabinet door and a sliding door mechanism. The refrigerator door having a thickness of 18-60 mm is rotatably connected to a refrigerator body by means of a hinge and is adapted to open or close a storage space of the refrigerator body; the cabinet door having a thickness of 12-26 mm is slidably arranged on an outer side of the refrigerator door; and the sliding door mechanism comprises a traction assembly and a sliding door assembly which are connected to each other, wherein the traction assembly is arranged on the hinge, the sliding door assembly is arranged on the refrigerator door and connected to the cabinet door, and the traction assembly is configured, during opening or closing of the refrigerator door, to drive the sliding door assembly to act, so as to drive the cabinet door to move in the direction of width relative to the refrigerator door. Thus, when the refrigerator door rotates relative to the refrigerator body, the sliding door assembly can be driven by the traction assembly to cause the cabinet door to move relative to the refrigerator door, thereby preventing the cabinet door from interfering with a cabinet when the refrigeration apparatus is embedded in the cabinet.

### CROSS-REFERENCES TO RELATED APPLICATIONS

The present application claims priority to Chinese patent application No. 202323218961.3 filed on Nov. 27, 2023, entitled “Refrigerator Hinge”, Chinese patent application No. 202410088590.1 filed on Jan. 22, 2024, entitled “Door Body Assembly and Refrigeration Device”, and Chinese patent application No. 202411187603.7 filed on Aug. 26, 2024, entitled “Door Body Device and Refrigeration Apparatus”, which are hereby incorporated by reference in their entireties.

### FIELD

The present application relates to the field of refrigeration apparatuses, and in particular, to a door body device, and a refrigeration apparatus.

### BACKGROUND

A refrigerator is an essential appliance in almost every household. Most traditional refrigerators are upright cabinet-style. Whether it is in a kitchen, a living room, etc., placement of the refrigerator requires a certain amount of space. To save space, some traditional refrigerators are placed together with cupboards in a built-in manner.

As shown in FIG. 1, to further enhance coordination and aesthetics, some refrigerators 10 in the built-in manner have a decorative panel 30 added at an outside of a refrigerator door 11, and it is ensured that the decorative panel 30 is flush with a cupboard 20 at a side of the refrigerator 10. However, in actual use, as shown in FIG. 2, a gap between the refrigerator 10 and the cupboard 20 is small. During a process of opening the refrigerator door 11, the decorative panel 30 interferes with the cupboard 20. To avoid interference, a general handling way is to reduce a door opening angle or increase the distance between the cupboard 20 and the side of the refrigerator 10. However, these ways affect the coordination and aesthetics, and also affect user experience.

### BRIEF SUMMARY

The present application provides a door device and a refrigeration apparatus, to avoid a problem of interference between a decorative panel and a cupboard during a process of opening a refrigerator door while ensuring coordination and aesthetics and not affecting user experience.

An embodiment of the present application provides a door body device, used for a refrigeration apparatus including a box body, including:
a box door, where the box door is rotatably connected to the box body through a hinge and configured to open or close a storage space of the box body, and a thickness of the box door is 18 mm to 60 mm;
a cupboard door, where the cupboard door is slidably provided at an outside of the box door, and a thickness of the cupboard door is 12 mm to 26 mm; and
a slide door mechanism, where the slide door mechanism includes a traction assembly and a slide door assembly connected to each other, the traction assembly being provided at the hinge, and the slide door assembly being provided at the box door and connected to the cupboard door; the traction assembly being configured to drive the slide door assembly to move during a process of opening or closing the box door, to drive the cupboard door to move in a width direction relative to the box door.

According to the door body device provided by the embodiments of the present application, a number of the box door is plural, each of the box doors corresponding to at least one of the storage space; and
each of the box doors is rotatably connected to the box body through a plurality of the hinges, and at least one of the hinges corresponds to each of the box doors being provided with the traction assembly.

According to the door body device provided by the embodiments of the present application, the hinge includes a first hinge, the first hinge being provided at a top wall of the body box; and/or a second hinge, the second hinge being provided at a front surface of the body box; and/or
a third hinge, the third hinge being provided at a front surface of the body box, the third hinge being located between the first hinge and the second hinge.

According to the door body device provided by the embodiments of the present application, the first hinge includes a first hinge plate and a first hinge shaft, a portion of the first hinge plate covering the top wall of the box body and a remaining portion of the first hinge plate protruding from the top wall toward a corresponding box door, the first hinge shaft extending downward from the portion of the first hinge plate protruding from the top wall, a top of the corresponding box door being hinged to the first hinge shaft, and the traction assembly being provided at one of the first hinge plate or the first hinge shaft.

According to the door body device provided by the embodiments of the present application, the second hinge includes a second hinge plate and a second hinge shaft, the second hinge plate including a support plate and an extension plate, the support plate being mounted at the front surface of the box body, the extension plate being connected to a side of the support plate away from the front of the box body, the support plate being provided at an angle to the extension plate, the second hinge shaft being provided at a top surface of the extension plate and extending upward, a bottom of a corresponding box door being hinged to the second hinge shaft, and the traction assembly being provided at one of the second hinge plate or the second hinge shaft.

According to the door body device provided by the embodiments of the present application, the third hinge includes a second hinge plate, a third hinge shaft and a fourth hinge shaft, the second hinge plate including a mount plate and a connect plate, the mount plate being mounted at the front surface of the box body, the connect plate being connected to a side of the mount plate away from the front surface of the box body, the connect plate being provided at an angle to the mount plate, the connect plate being provided with a first side and a second side opposite to each other, the third hinge shaft being provided at the first side, a bottom of the corresponding box door being hinged to the third hinge shaft, the fourth hinge shaft being provided at the second side, a top of the corresponding box door being hinged to the fourth hinge shaft, and the third hinge being provided with at least one of the traction assembly.

According to the door body device provided by the embodiments of the present application, the third hinge is provided with one traction assembly, the traction assembly being provided at one of the mount plate, the connect plate, the third hinge shaft, or the fourth hinge shaft; or
the third hinge is provided with two traction assemblies, both of the two traction assemblies being provided at one of the mount plate or the connect plates, or the two traction assemblies being provided at the third hinge shaft and the fourth hinge shaft, respectively; or
the third hinge is provided with two traction assemblies, one of the two traction assemblies being provided at one of the mount plate or the connect plate, another one of the two traction assemblies being provided at one of the third hinge shaft and the fourth hinge shaft.

According to the door body device provided by the embodiments of the present application, the door body device and the box body are configured to be provided in a mount space formed between a first cupboard body and a second cupboard body; during the process of opening or closing the box door, the slide door mechanism is configured to drive the cupboard door to move a preset distance at the box door, to allow the cupboard door to avoid a side wall of the first cupboard body and a side wall of the second cupboard body; or
the door body device and the box body are configured to be provided in a cupboard body; during the process of opening or closing the box door, the slide door mechanism is configured to drive the cupboard door to move a preset distance at the box door, to allow the cupboard door to avoid a side wall of the cupboard.

According to the door body device provided by the embodiments of the present application, the hinge includes a hinge plate and a hinge shaft provided at the hinge plate, the hinge plate being provided at the box body, the box door being rotatably provided at the box body through the hinge shaft;
the traction assembly includes a traction rod, a first rotate shaft fixation base, and a second rotate shaft fixation base,
the first rotate shaft fixation base being connected to the slide door assembly, the second rotate shaft fixation base being connected to the hinge plate, a first end of the traction rod being rotatably connected to the first rotate shaft fixation base, and a second end of the traction rod being rotatably connected to the second rotate shaft fixation base; and
during the process of opening or closing the box door, the traction rod drives the slide door assembly to move, to drive the cupboard door to move in the width direction relative to the box door.

According to the door body device provided by the embodiments of the present application, the slide door assembly includes:
a base being formed with a first guide rail at a side and a second guide rail at another side;
a first slider being slidably provided at the first guide rail, the traction assembly being connected to the first slider;
a second slider being slidably provided at the second guide rail and connected to the cupboard door; and
a connector having two ends connected to the first slider and the second slider, respectively;
where during the process of opening or closing the box door, the traction assembly drives the first slider to move at the first guide rail, and the first slider drives, through the connector, the second slider to move in an opposite direction at the second guide rail.

According to the door body device provided by the embodiments of the present application, the connector includes:
a first connector passing around a first end of the base and having two ends connected to a first end of the first slider and a first end of the second slider, respectively; and
a second connector passing around a second end of the base and having two ends connected to a second end of the first slider and a second end of the second slider, respectively.

An embodiment of the present application further provides a refrigeration apparatus, including:
a box body being formed with a storage space; and
the door body device provided by the embodiments of the present application, where a box door is rotatably connected to the box body through a hinge and is configured to open or close the storage space of the box body.

The door body device provided by the embodiments of the present application includes a box door, a cupboard door and a slide door mechanism. After the door body device provided by the embodiments of the present application is mounted at the box body of the refrigeration apparatus, during a rotation of the box door relative to the box body, the slide door assembly may allow the cupboard door to move relative to the box door under drive of the traction assembly. As such, in case that the refrigeration apparatus is placed in a cupboard in a built-in manner, interference between the cupboard door and the cupboard may be avoided during the process of opening the box door while ensuring coordination and aesthetics and not affecting user experience.

In addition to the problems solved by the present application, the technical features that constitute the solutions, and the advantages brought by the solutions having these technical features described above, other technical features of the present application and the advantages brought by these technical features are further described in conjunction with the accompanying drawings.

### BRIEF DESCRIPTION OF THE DRAWINGS

To illustrate the solutions disclosed in the embodiments of the present application or the related art more clearly, the drawings used in the description of the embodiments or the related art are briefly described below. The drawings in the following description are only some embodiments of the present application, and other drawings may be obtained according to these drawings without any creative work for those skilled in the art.

FIG. 1 is a schematic structural diagram of a refrigerator in a related art, placed in a built-in manner within a cupboard, where an outside of the refrigerator door is provided with a decorative panel, and the refrigerator door is in a closed position;

FIG. 2 is a schematic structural diagram of a refrigerator in a related art, placed in a built-in manner within a cupboard, where an outside of the refrigerator door is provided with a decorative panel, and the refrigerator door is in an open position;

FIG. 3 is a schematic structural diagram of a refrigeration apparatus provided with a door body device according to an embodiment of the present application;

FIG. 4 is a schematic structural diagram of a refrigeration apparatus, provided with a door body device, during sliding according to an embodiment of the present application;

FIG. 5 is a schematic structural diagram of a first hinge in a door body device according to an embodiment of the present application;

FIG. 6 is a schematic structural diagram of a second hinge in a door body device according to an embodiment of the present application;

FIG. 7 is a schematic structural diagram of a third hinge in a door body device according to an embodiment of the present application;

FIG. 8 is a schematic structural diagram of a connection between a first hinge in a door body device and a box door according to an embodiment of the present application;

FIG. 9 is a schematic structural diagram of a connection between a second hinge in a door body device and a box door according to an embodiment of the present application;

FIG. 10 is a schematic structural diagram of a connection between a third hinge in a door body device and a box door according to an embodiment of the present application;

FIG. 11 is a schematic structural diagram of a slide door mechanism in a door body device according to one embodiment of the present application;

FIG. 12 is a schematic structural diagram of a slide door mechanism shown in FIG. 11 from another perspective;

FIG. 13 is a schematic structural diagram of a slide door mechanism in a door body device according to another embodiment of the present application;

FIG. 14 is a schematic structural diagram of a slide door mechanism shown in FIG. 13 from another perspective; and

FIG. 15 is a schematic structural diagram of a slide door mechanism shown in FIG. 13 after disassembly.

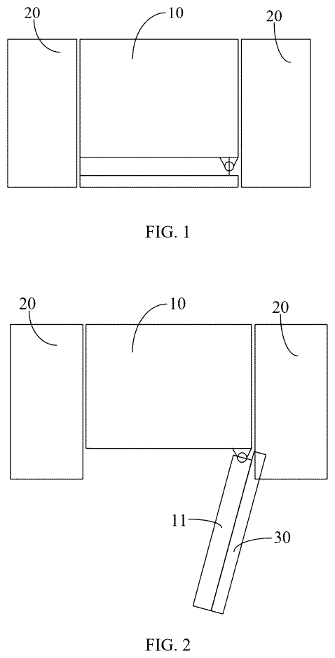

### REFERENCE SIGNS

10, refrigerator; 11, refrigerator door; 20, cupboard; 30, decorative panel;
110, box door; 111, first box door; 112, second box door; 200, cupboard door; 300, slide door mechanism; 310, traction assembly; 311, traction rod; 312, first rotate shaft fixation base; 313, second rotate shaft fixation base; 320, slide door assembly; 321, base; 3211, first guide rail; 3212, second guide rail; 322, first slider; 323, second slider; 324, connector; 3241, first connector; 3242, second connector; 325, joint plate; 326, first receive plate; 327, second receive plate; 328, first roller; 329, second roller; 400, hinge; 410, first hinge; 411, first hinge plate; 412, first hinge shaft; 413, vertical plate; 420, second hinge; 421, second hinge plate; 4211, support plate; 4212, extension plate; 422, second hinge shaft; 430, third hinge; 431, third hinge plate; 4311, mount plate; 4312, connect plate; 432, third hinge shaft; 433, fourth hinge shaft; 500, box body; 510, first cupboard body; 520, second cupboard body.

### DETAILED DESCRIPTION

Implementations of the present application are described in further detail below in conjunction with the accompanying drawings and embodiments. The following embodiments are used to illustrate the present application, but are not intended to limit the scope of the present application.

In the description of the embodiments of the present application, it is to be noted that the orientation or positional relationships indicated by terms such as “center”, “longitudinal”, “lateral”, “upper”, “lower”, “front”, “rear”, “left”, “right”, “vertical”, “horizontal”, “top”, “bottom”, “inside”, “outside”, etc. are based on the orientation or positional relationship shown in the drawings, and are merely for the convenience of describing the embodiments of the present application and simplifying the description, rather than indicating or implying that the device or component stated must have a particular orientation, is constructed and operated in a particular orientation, and thus is not to be construed as limiting the embodiments of the present application. Moreover, the terms “first”, “second”, “third”, and the like are used for descriptive purposes only and are not to be construed as indicating or implying relative importance. In addition, in the description of the present application, unless otherwise specified, “multiple”, “multiple pieces”, and “multiple groups” mean two or more.

In the description of the present application, it should be noted that unless explicitly specified and defined otherwise, the terms “connected to” and “connected” shall be understood broadly, for example, it may be either fixedly connected or detachably connected, or can be integrated; it may be either mechanically connected, or electrically connected; it may be either directly connected, or indirectly connected through an intermediate medium. The specific meanings of the terms above in the present application can be understood by a person skilled in the art in accordance with specific conditions.

In the embodiments of this application, unless otherwise clearly stated and defined, the first feature being located “on” or “under” the second feature means that the first feature is in direct contact with the second feature or the first feature is in contact with the second feature by an intervening media. In addition, the first feature is “on”, “above” and “over” the second feature can refer to that the first feature is directly above or obliquely above the second feature, or simply refer to that the level height of the first feature is higher than that of the second feature. The first feature is “under”, “below” and “beneath” the second feature can refer to that the first feature is directly below or obliquely below the second feature, or simply refer to that the level height of the first feature is lower than that of the second feature.

In the description of this specification, description with reference to the terms “one embodiment”, “some embodiments”, “an example”, “specific example”, “some examples” and the like, refers to that specific features, structures, materials or characteristics described in combination with an embodiment or an example are included in at least one embodiment or example according to the embodiments of the present application. In this specification, schematic representations of the above terms are not necessarily directed to a same embodiment or example. Furthermore, the particular features, structures, materials or characteristics described can be combined in any suitable manner in any one or more embodiments or examples. In addition, those skilled in the art may combine the different embodiments or examples described in this specification, as well as the features of the different embodiments or examples, without conflicting each other.

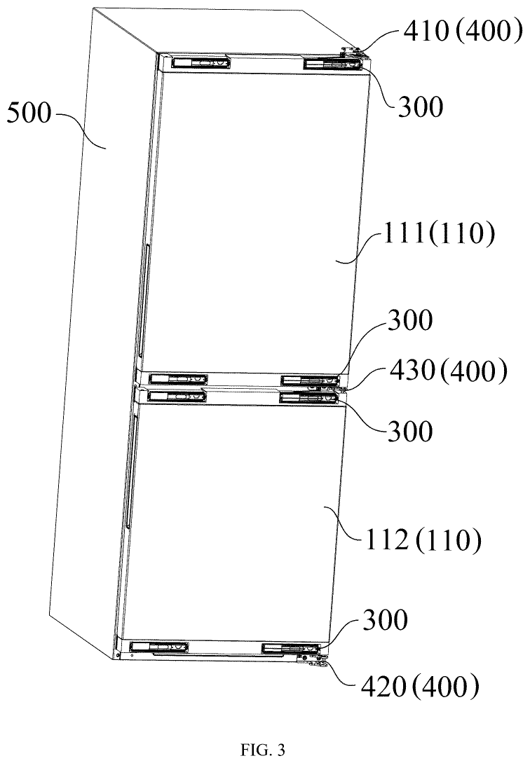

An embodiment of the present application provides a door body device and a refrigeration apparatus. The door body device is used for the refrigeration apparatus. The door body device includes a box door, a cupboard door, and a slide door mechanism. In case that the refrigeration apparatus is placed together with a cupboard in a built-in manner or directly in the cupboard, a cupboard door is slidably provided at an outer side of the box door. In case that the box door is closed, the cupboard door may be flush with a door panel of the cupboard, ensuring coordination and aesthetics. In case that the box door is opened, the slide door mechanism may drive the cupboard door to move to avoid interference between the cupboard door and the door panel of the cupboard, improving user experience. The door body device and the refrigeration apparatus in this embodiment are further described below with reference to FIG. 3 to FIG. 15.

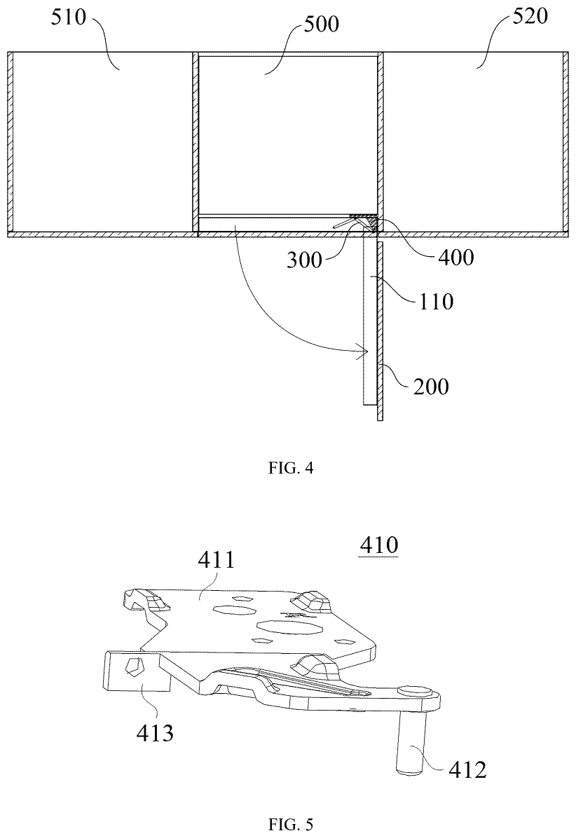

As shown in FIG. 3 and FIG. 4, the door body device in this embodiment includes: a box door 110, a cupboard door 200, and a slide door mechanism 300.

The box door 110 is rotatably connected to the box body 500 through a hinge 400, and is configured to open or close a storage space of the box body 500. The cupboard door 200 is slidably provided at an outside of the box door 110. The slide door mechanism 300 includes a traction assembly 310 and a slide door assembly 320 connected to each other, the traction assembly 310 being provided at the hinge 400, the slide door assembly 320 being provided at the box door 110 and connected to the cupboard door 200, and the traction assembly 310 being configured to drive the slide door assembly 320 to move during a process of opening or closing the box door 110, to drive the cupboard door 200 to move in a width direction relative to the box door 110.

A thickness of the box door 110 is 18-60 mm, for example, the thickness of the box door 110 is 18 mm, 25 mm, 50 mm, 60 mm, etc. A thickness of the cupboard door 200 is 12-26 mm, for example, the thickness of the cupboard door 200 is 12 mm, 18 mm, 24 mm, 26 mm, etc. In addition, the cupboard door 200 may be a wooden door, a plastic door, etc.

The door body device in this embodiment may be used in refrigeration apparatuses such as a refrigerator, a freezer, an ice maker, etc. The refrigeration apparatus includes a box body 500, the box body 500 being formed with a storage space. The storage space may be used to store items such as vegetables, fruits, etc., that require refrigeration or freezing. In an embodiment, a refrigeration device or the like is further provided in the box body 500, where the refrigeration device may cool the storage space.

In this embodiment, the box door 110 of the door body device is rotatably provided at the box body 500 of the refrigeration apparatus through the hinge 400. The box door 110 may be used to open or close the storage space within the box body 500. In case that the box door 110 is in a closed position to close the storage space, the storage space is in a sealed state, and items within the storage space may be cooled. In case that the box door 110 is in an open position to open the storage space, the storage space is in an open state, and a user may access items within the storage space.

To facilitate description of positional relationships between various components, in this embodiment, as shown in FIG. 3, the box body 500 is generally constructed as a rectangular parallelepiped structure having a certain height. The box body 500 may be placed at a horizontal surface. The box body 500 has a height direction, a width direction and a thickness direction which are perpendicular to each other. The height direction of the box body 500 is parallel to a vertical direction, and the width direction and the thickness direction are located within a horizontal plane and are mutually perpendicular.

The storage space is provided within the box body 500. An opening is provided at a side portion of the box body 500 in the thickness direction. The opening communicates with the storage space. The box door 110 is connected to the side portion of the box body 500 in the thickness direction provided with the opening. The box door 110 is provided extending along the width direction of the box body 500. The hinge 400 is connected to a side of the box door 110 in the width direction of the box body 500. The box door 110 may be rotatably connected to the box body 500 through the hinge 400. As such, it is ensured that the box door 110 may open or close the storage space of the box body 500.

In an embodiment, a side of the box body 500 where the box door 110 is mounted is the front surface. That is, the box door 110 is mounted at the front surface of the box body 500.

The box door 110 is generally constructed as a flat plate having a certain thickness. The box door 110 has a height direction, a width direction, and a thickness direction that are perpendicular to each other. The height direction of the box door 110 is parallel to a vertical direction, and the width direction and the length direction are located in a horizontal plane and are perpendicular to each other. A side of the box door 110 in the width direction may be rotatably connected to the box body 500 through the hinge 400. For example, as shown in FIG. 3, the box door 110 is connected to the hinge 400 at a right side of the width direction of the box body 500, and the box door 110 may be rotatably connected to the box body 500 through the hinge 400.

In an embodiment, in case that the box door 110 is in a position closing the storage space of the box body 500, the width direction of the box door 110 is parallel to the width direction of the box body 500, and the thickness direction of the box door 110 is parallel to the thickness direction of the box body 500.

In an embodiment, the cupboard door 200 may be a decorative door panel. The cupboard door 200 is constructed as a flat plate having a certain thickness. The cupboard door 200 is connected to an outside of the box door 110 away from the box body 500. In case that the refrigeration apparatus is placed in a built-in manner with a cupboard or directly in the cupboard, after the box door 110 is in the closed position, the cupboard door 200 may be flush with the cupboard door panel. That is, an outer wall surface of the cupboard door 200 away from the box door 110 may be flush with an outer wall surface of the cupboard.

In an actual use scenario, the outer wall surface of the cupboard door 200 may be made of a same material and shape as the outer wall surface of the cupboard, and may be decorated with a same decoration. As such, the refrigeration apparatus may be sufficiently coordinated with the cupboard and maintain aesthetics.

In this embodiment, after the door body device is mounted at the box body 500 of the refrigeration apparatus, in case that the box door 110 rotates relative to the box body 500 to open or close the storage space of the box body 500, the slide door mechanism 300 may drive the cupboard door 200 to move relative to the box door 110 in the width direction of the box door 110. As such, in case that the refrigeration apparatus is placed in a built-in manner in the cupboard, the cupboard door 200 may be prevented from interfering with the cupboard during a process of opening the box door 110, while ensuring coordination and aesthetics and not affecting the user experience.

In an embodiment, as shown in FIG. 4, the door body device and the box body 500 are configured to be provided within a mount space formed between a first cupboard body 510 and a second cupboard body 520; during a process of opening or closing the box door 110, the slide door mechanism 300 is configured to drive the cupboard door 200 to move a predetermined distance at the box door 110, and the cupboard door 200 avoids sidewalls of the first cupboard body 510 and the second cupboard body 520; or
the door body device and the box body 500 are configured to be provided within a cupboard body; during a process of opening or closing the box door 110, the slide door mechanism 300 is configured to drive the cupboard door 200 to move a predetermined distance at the box door 110, and the cupboard door 200 avoids a sidewall of the cupboard body.

The refrigeration apparatus includes the door body device and the box body 500.

In practice, as shown in FIG. 4, in case that a refrigeration apparatus having the door body device and the box body 500 is placed between adjacent first cupboard body 510 and second cupboard body 520, a cupboard door 200 may be provided outside the box door 110 in the door body device. The cupboard door 200 may move relative to the box door 110 along the width direction of the box door 110. In an embodiment, in case that the box door 110 is in a state of closing the storage space of the box body 500, the outer wall surface of the cupboard door 200 away from the box door 110 may be flush with outer wall surfaces of the first cupboard body 510 and the second cupboard body 520. The outer wall surfaces of the first cupboard body 510 and the second cupboard body 520, and the outer wall surface of the cupboard door 200 away from the box door 110 are aligned in a same direction in the thickness direction of the box body 500.

In this case, during a process that the box door 100 rotates relative to the box body 500, the slide door mechanism 300 may drive the cupboard door 200 to move, allowing the cupboard door 200 to avoid the side walls of the first cupboard body 510 and the second cupboard body 520.

In an embodiment, after the refrigeration apparatus is placed in the cupboard body, the cupboard door 200 may be provided outside the box door 110 of the door body device, and the cupboard door 200 may move relative to the box door 110. In an embodiment, in case that the box door 110 is in a state of closing the storage space of the box body 500, the outer wall surface of the cupboard door 200 away from the box door 110 may be flush with the outer wall surface of the cupboard body, and the outer wall surface of the cupboard body and the outer wall surface of the cupboard door 200 away from the box door 110 are aligned in a same direction in the thickness direction of the box body 500.

In this case, during a process that the box door 110 rotates relative to the box body 500, the slide door mechanism 300 may drive the cupboard door 200 to move, and may also allow the cupboard door 200 to avoid the side wall of the cupboard body.

In an embodiment, in the slide door mechanism 300 of this embodiment, as shown in FIG. 11 and FIG. 13, the traction assembly 310 is provided at the hinge 400, the slide door assembly 320 is provided at the box door 110, and the slide door assembly 320 is also connected to the cupboard door 200. During the rotation of the box door 110 relative to the box body 500, the traction assembly 310 may drive the slide door assembly 320 to move, driving the cupboard door 200 to move relative to the box door 110.

For example, since the hinge 400 is fixedly connected to the box body 500, during the rotation of the box door 110 relative to the box body 500, the traction assembly 310 may apply a pulling force to the slide door assembly 320, and the slide door assembly 320 then drives the cupboard door 200 to move based on this pulling force.

After the door body device in this embodiment is mounted at the box body 500 of the refrigeration apparatus, during the rotation of the box door 110 relative to the box body 500, the slide door assembly 320 may allow the cupboard door 200 to move relative to the box door 110 under the drive of the traction assembly 310. As such, in case that the refrigeration apparatus is placed in the cupboard in the built-in manner, the cupboard door 200 may be prevented from interfering with the cupboard during the process of opening the box door 110 while ensuring coordination and aesthetics and not affecting the user experience.

In an embodiment, a number of the box door 110 is plural, each of the box doors 110 corresponding to at least one of the storage space, each of the box doors 110 being rotatably connected to the box body 500 through a plurality of the hinges 400, and at least one of the hinges 400 corresponding to each of the box doors 110 being provided with the traction assembly 310.

Depending on different cooling requirements, the box body 500 of different refrigeration apparatuses may be provided with different numbers of storage spaces. These storage spaces are spaced apart along the height direction of the box body 500, with some storage spaces being used for refrigeration and some storage spaces being used for freezing. To enable targeted closure of these storage spaces, the number of box doors 110 may be plural, each box door 110 corresponding to at least one of the storage spaces.

For example, as shown in FIG. 3, the box body 500 is provided with two storage spaces spaced apart in the vertical direction. The two storage spaces may be used for refrigeration and freezing, respectively. The number of the box doors 110 is two, namely a first box door 111 and a second box door 112. The two box doors 110 correspond one-to-one with positions of the two storage spaces. In this case, the two storage spaces may be opened or closed separately by the two box doors 110.

For another example, the box body 500 may be provided with three storage spaces spaced apart in the vertical direction, namely, a first space, a second space, and a third space. The first space and the second space are used for refrigeration, and the third space is used for freezing. The number of the box doors 110 is two, namely a first box door 111 and a second box door 112. The first box door 111 corresponds one-to-one with positions of the first space and the second space simultaneously, and the second box door 112 corresponds to a position of the third space. In this case, the first box door 111 may open or close the first space and the second space simultaneously, and the second box door 112 may be used to independently control opening or closing state of the third space.

In this embodiment, each box door 110 may correspond to a single storage space. In this case, the opening or closing state of the storage space may be independently controlled by the box door 110. In another embodiment, according to requirements, each door 110 may also correspond to a plurality of adjacent storage spaces. In this case, the opening or closing state of the plurality of storage spaces may be controlled simultaneously by the box door 110.

In an embodiment, as shown in FIG. 3, the hinge 400 includes a first hinge 410 and a second hinge 420. The first hinge 410 is provided at the top wall of the box body 500, and the second hinge 420 is provided at the front surface of the box body 500.

For example, in case that the number of the box doors 110 is plural, the plurality of box doors 110 may be spaced apart along the height direction of the box body 500. In this case, a box door 110 at a top may be rotatably connected to the box body 500 through a first hinge 410, and a box door 110 at a bottom may be rotatably connected to the box body 500 through a second hinge 420.

By providing the first hinge 410 and the second hinge 420, the box door 110 at the top and the box door 110 at the bottom may open or close their corresponding storage spaces, respectively.

In an embodiment, as shown in FIG. 3, the box door 110 includes a first box door 111 and a second box door 112. The first box door 111 and the second box door 112 are provided at intervals along a height direction of the box body 500. In this case, a top of the first box door 111 may be rotatably connected to the box body 500 by the first hinge 410, and a bottom of the second box door 112 may be rotatably connected to the box body 500 by the second hinge 420.

In an embodiment, to effectively mount the box door 110, the hinge 400 may further include a third hinge 430. The second hinge 430 is provided at the front surface of the box body 500 and is located between the first hinge 410 and the second hinge 420.

For example, since the plurality of box doors 110 are spaced apart along the height direction of the box body 500, the third hinge 420 may be provided between two adjacent box doors 110, and at least one of the two adjacent box doors 110 may be rotatably connected to the box body 500 through the third hinge 430.

In a practical application, a number of the third hinge 430 may be one or two. For example, in case that the number of the third hinge 430 is one, one of two adjacent box doors 110 may be connected to the third hinge 430 and rotatably connected to the box body 500 through the third hinge 430. Alternatively, the two adjacent doors 110 may be simultaneously connected to the third hinge 430 and rotatably connected to the box body 500 through the third hinge 430.

For example, as shown in FIG. 3, the door 110 includes a first box door 111 and a second box door 112. In this case, the third hinge 430 may be provided between the first box door 111 and the second box door 112. A bottom of the first door 111 and a top of the second door 112 may be simultaneously hinged to the third hinge 430, being rotatably connected to the box body 500.

In an embodiment, as shown in FIG. 5, the first hinge 410 includes a first hinge plate 411 and a first hinge shaft 412. A portion of the first hinge plate 411 covers the top wall of the box body 500 and a remaining portion of the first hinge plate 411 protrudes from the top wall toward a corresponding box door 110. The first hinge shaft 412 extends downward from a portion of the first hinge plate 411 protruding from the top wall. A top of the corresponding box door 110 is hinged to the first hinge shaft 412. The traction assembly 310 is provided at one of the first hinge plate 411 or the first hinge shaft 412.

For example, the first hinge plate 411 and the first hinge shaft 412 may be made of a metal or non-metal material having a certain structural strength. The first hinge plate 411 includes a first abut portion and a first protrusion portion connected to each other. The first abut portion is provided with a plurality of mount holes. The first hinge shaft 412 is fixed to the first protrusion portion by welding or threading.

During actual mounting, a plurality of threaded holes may be pre-set at the top wall of the box body 500. The first abut portion of the first hinge plate 411 may then be abutted against the top wall of the box body 500, with the mount holes at the first abut portion aligned with the threaded holes. The first abut portion may then be fixed to the top wall of the box body 500 using bolts. The first abut portion may cover and abut against the top wall of the box body 500, the first protrusion portion may protrude from the top wall toward the box door 110, and the first hinge shaft 412 may extend downward along the height direction of the box body 500.

In an embodiment, in case of mounting the box door 110, a hinge hole may be pre-set at the top of the box door 110 corresponding to the first hinge 410. The first hinge shaft 412 may then be inserted into the hinge hole, achieving mounting of the box door 110.

A box door 110 corresponding to the first hinge 410 is connected to the slide door mechanism 300. For example, the slide door mechanism 300 is connected to the top of the first box door 111. The traction assembly 310 in the slide door mechanism 300 may be provided at the first hinge plate 411 or at the first hinge shaft 412.

For example, as shown in FIG. 5, in an embodiment, a vertical plate 413 is provided at the first hinge plate 411. The vertical plate 413 extends downward along a thickness direction of the first hinge plate 411 and is provided with a mount hole.

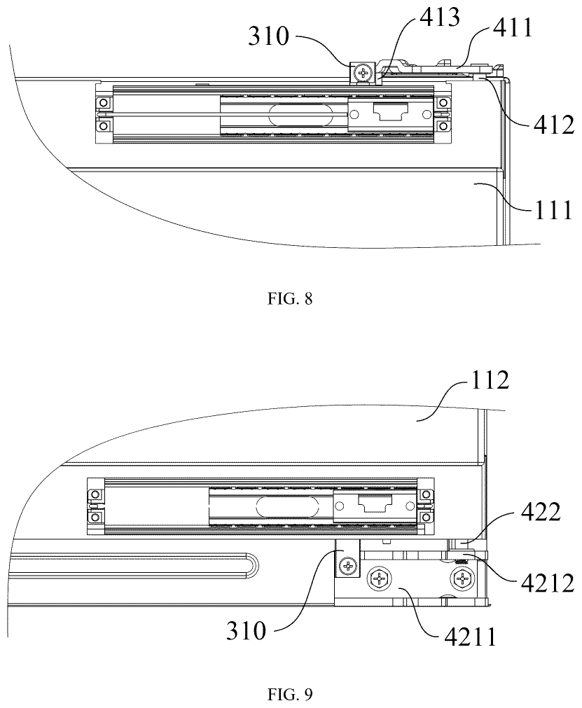

As shown in FIG. 8, during actual mounting, the first hinge plate 411 is fixed to the top wall of the box body 500, the first box door 111 is rotatably connected to the first hinge shaft 412, and a portion of a structure of the traction assembly 310 may be connected to the vertical plate 413 by bolts.

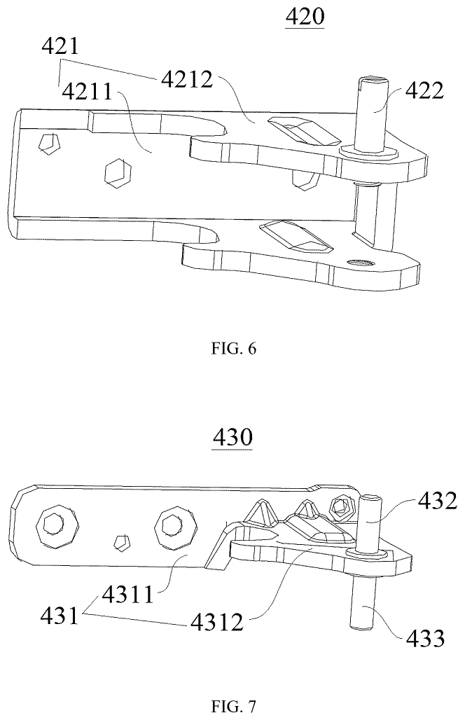

In an embodiment, as shown in FIG. 6, the second hinge 420 includes a second hinge plate 421 and a second hinge shaft 422. The second hinge plate 421 includes a support plate 4211 and an extension plate 4212. The support plate 4211 is mounted at the front surface of the box body 500. The extension plate 4212 is connected to a side of the support plate 4211 away from the front surface of the box body 500. The support plate 4211 is provided at an angle to the extension plate 4212. The second hinge shaft 422 is provided at a top surface of the extension plate 4212 and extends upward. The bottom of the corresponding box door 110 is hinged to the second hinge shaft 422. The traction assembly 310 is provided at one of the second hinge plate 421 or the second hinge shaft 422.

Similarly, the second hinge plate 421 and the second hinge shaft 422 may also be made of metal or non-metal materials with a certain structural strength. The second hinge plate 421 includes a support plate 4211 and an extension plate 4212 connected to each other. The extension plate 4212 is approximately perpendicular to the support plate 4211. The extension plate 4212 and the support plate 4211 may be integrally formed by stamping or other manners. The support plate 4211 is provided with a plurality of mount holes. The second hinge shaft 422 is fixed to the extension plate 4212 by welding, threading, or other connection manners.

During actual mounting, a plurality of threaded holes may be pre-set at the front surface of the box body 500 near the bottom. A side of the support plate 4211 in a thickness direction is fitted to the front surface of the box body 500, and the mount holes at the support plate 4211 are made to correspond to positions of the threaded holes. Then, the support plate 4211 is fixed to the front surface of the box body 500 by bolts. The extension plate 4212 is connected to another side of the support plate 4211 in the thickness direction and extends toward a direction where the box door 110 is located. The second hinge shaft 422 extends upward along the height direction of the box body 500.

In an embodiment, in case of mounting the door 110, a hinge hole may be pre-set at the bottom of the box door 110 corresponding to the second hinge 420. The second hinge shaft 422 may then be inserted into the hinge hole, achieving mounting of the box door 110.

The box door 110 corresponding to the second hinge 420 is connected to the slide door mechanism 300. For example, the bottom of the second box door 112 is connected to the slide door mechanism 300. The traction assembly 310 in the slide door mechanism 300 may be provided at the second hinge plate 421 or at the second hinge shaft 422.

As shown in FIG. 9, during actual mounting, the support plate 4211 is fixed to the front surface of the box body 500 near the bottom, the second box door 112 is rotatably connected to the second hinge shaft 422, and a portion of a structure of the traction assembly 310 may be connected to the support plate 4211 by bolts.

In an embodiment, as shown in FIG. 7, the third hinge 430 includes a third hinge plate 431, a third hinge shaft 432 and a fourth hinge shaft 433. The third hinge plate 431 includes a mount plate 4311 and a connect plate 4312. The mount plate 4311 is mounted at the front surface of the box body 500. The connect plate 4312 is connected to a side of the mount plate 4311 away from the front surface of the box body 500. The connecting plate 4312 is provided at an angle to the mount plate 4311. The connecting plate 4312 has a first side and a second side opposite to each other. The third hinge shaft 432 is provided at the first side. The bottom of the corresponding box door 110 is hinged to the third hinge shaft 432. The fourth hinge shaft 433 is provided at the second side. The top of the corresponding box door 110 is hinged to the fourth hinge shaft 433. The third hinge 430 is provided with at least one traction assembly 310.

For example, the third hinge plate 431, the third hinge shaft 432, and the fourth hinge shaft 433 may be made of a metal or non-metal material with a certain structural strength. The third hinge plate 431 includes a mount plate 4311 and a connect plate 4312 connected to each other. The connect plate 4312 is approximately perpendicular to the mount plate 4311. The mount plate 4311 is provided with a plurality of mount holes. During actual production, the mount plate 4311 and the connect plate 4312 may be integrally formed from a same plate, and then the connect plate 4312 may be bent relative to the mount plate 4311 by stamping and folding.

The connect plate 4312 has two sides in the thickness direction, namely a first side and a second side. The first side is fixedly connected to the third hinge shaft 432, and the second side is fixedly connected to the fourth hinge shaft 433.

During actual production, the third hinge shaft 432 and the fourth hinge shaft 433 may be fixedly connected to the connect plate 4312 by welding. Alternatively, the third hinge shaft 432 and the fourth hinge shaft 433 may be constructed as an integrated, elongated, and rod-shaped member. The connect plate 4312 is provided with a through-hole penetrating through its thickness direction. The integrated member is inserted into the through-hole and fixed in the through-hole by welding or threading. Two ends of the integrated member in the longitudinal direction of the connect plate 4312 are respectively formed as the third hinge shaft 432 and the fourth hinge shaft 433.

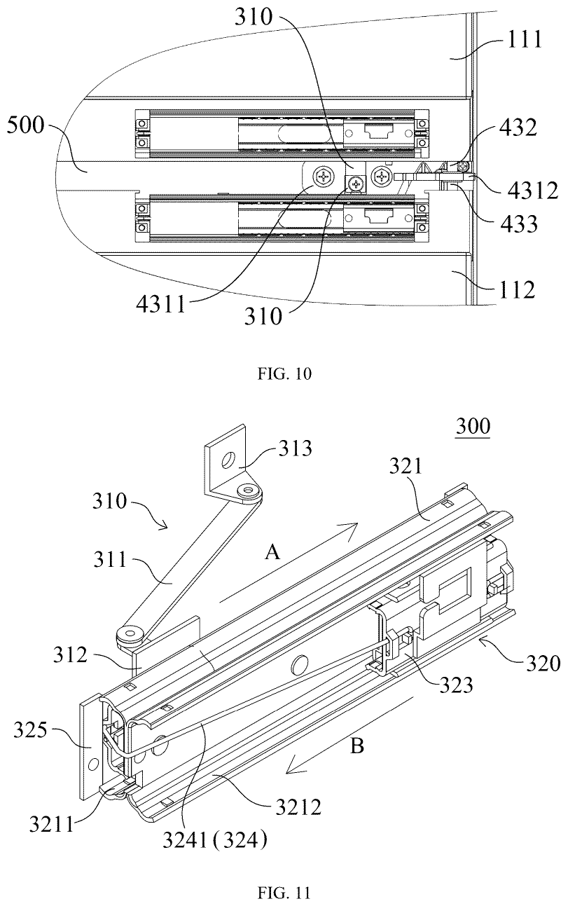

During actual mounting, as shown in FIG. 10, a plurality of threaded holes may be pre-set at the front surface of the box body 500 based on a mount position of the box door 110. For example, as shown in FIG. 3, a plurality of threaded holes may be set at the front surface of the box body 500 at positions corresponding to a gap between the first box door 111 and the second box door 112. Mount holes at the mount plate 4311 of the third hinge plate 431 are then aligned with the threaded holes. The mount plate 4311 is then fixed to the front surface of the box body 500 using bolts. The connect plate 4312 extends toward a direction of the box door 110. The third hinge shaft 432 extends upward along the height direction of the box body 500, and the fourth hinge shaft 433 extends downward along the height direction of the box body 500.

In an embodiment, in case of mounting the box door 110, a hinge hole may be pre-set at the bottom of the box door 110 corresponding to the third hinge shaft 432, and a hinge hole may be pre-set at the top of the box door 110 corresponding to the fourth hinge shaft 433. The third hinge shaft 432 and the fourth hinge shaft 433 may then be respectively inserted into the hinge holes of the corresponding box doors 110, achieving mounting of the box door 110.

In an embodiment, as shown in FIG. 3, a box body 500 is provided with two storage spaces spaced apart along its height direction. A first hinge 410 is provided at the top of the box body 500. A second hinge 420 is provided at the bottom of the box body 500. A third hinge 430 is provided at the middle of the box body 500, approximately between the two storage spaces. The door body device includes two box doors 110, namely a first box door 111 and a second box door 112. The first box door 111 and the second box door 112 are spaced apart along the height direction of the box body 500. The first box door 111 and the second box door 112 correspond to the two storage spaces of the box body 500, respectively.

During mounting, the top of the first box door 111 is hinged to the first hinge shaft 412 of the first hinge 410, the bottom of the first box door 111 is hinged to the third hinge shaft 432 of the third hinge 430, the top of the second box door 112 is hinged to the fourth hinge shaft 433 of the third hinge 430, and the bottom of the second box door 112 is hinged to the second hinge shaft 422 of the second hinge 420.

Through the above arrangement, the first box door 111 and the second box door 112 may be rotatably connected to the box body 500.

In an embodiment, the third hinge 430 may be provided with at least one traction assembly 310. For example, the third hinge 430 may be provided with only one traction assembly 310, and the traction assembly 310 may be connected to the third hinge plate 431, the third hinge shaft 432, or the fourth hinge shaft 433.

In this embodiment, the third hinge 430 is provided with a traction assembly 310, and the traction assembly 310 is provided at one of the mount plate 4311, the connect plate 4312, the third hinge shaft 432, or the fourth hinge shaft 433.

For example, the first box door 111 or the second box door 112 corresponding to the third hinge 430 is connected to the slide door mechanism 300, and the traction assembly 310 in the slide door mechanism 300 may be connected to the mount plate 4311, the connect plate 4312, the third hinge shaft 432, or the fourth hinge shaft 433. In this case, the third hinge 430 may be provided with only one traction assembly 310.

In an embodiment, the third hinge 430 is provided with two traction assemblies 310. Both of the two traction assemblies 310 are provided at one of the mount plate 4311 or the connect plate 4312, or are provided at the third hinge shaft 432 and the fourth hinge shaft 433, respectively.

For example, both the first box door 111 and the second box door 112 corresponding to the third hinge 430 are connected to the slide door mechanism 300, the two traction assemblies 310 in the two slide door mechanisms 300 are simultaneously connected to the mount plate 4311 or the connect plate 4312, or portions of the two traction assemblies 310 may be connected to the third hinge shaft 432 and the fourth hinge shaft 433, respectively.

In an embodiment, the third hinge 430 is provided with two traction assemblies 310. One traction assembly 310 is provided at one of the mount plate 4311 or the connect plate 4312, and another traction assembly 310 is provided at one of the third hinge shaft 432 or the fourth hinge shaft 433.

For example, both the first box door 111 and the second box door 112 corresponding to the third hinge 430 are connected to the slide door mechanism 300. Both of the two slide door mechanisms 300 include a traction assembly 310. One of the two slide door mechanisms 300 is connected to the mount plate 4311 or the connect plate 4312, and another one of the two slide door mechanisms 300 is connected to the third hinge shaft 432 or the fourth hinge shaft 433. For example, a portion of a structure of one traction assembly 310 is connected to the mount plate 4311, and a portion of a structure of another traction assembly 310 is connected to the fourth hinge shaft 433.

For example, as shown in FIG. 10, the first box door 111 and the second box door 112 are connected to a slide door mechanism 300, respectively. The traction assemblies 310 in the two sliding door mechanisms 300 may be fixedly connected to the mount plate 4311 through a same bolt.

In an embodiment, to ensure that the traction assembly 310 may drive the slide door assembly 320 to move, the hinge 400 includes a hinge plate and a hinge shaft provided at the hinge plate. The hinge plate is provided at the box body 500, and the box door 110 is rotatably provided at the box body 500 through the hinge shaft. As shown in FIG. 11 and FIG. 13, the traction assembly 310 includes a traction rod 311, a first rotate shaft fixation base 312 and a second rotate shaft fixation base 313; the first rotate shaft fixation base 312 is connected to the slide door assembly 320, the second rotate shaft fixation base 313 is connected to the hinge plate, a first end of the traction rod 311 is rotatably connected to the first rotate shaft fixation base 312, and a second end of the traction rod 311 is rotatably connected to the second rotate shaft fixation base 313; and in the process of opening or closing the box door 110, the traction rod 311 drives the slide door assembly 320 to move, driving the cupboard door 200 to move relative to the width direction of the box door 110.

For example, the hinge 400 may include a hinge plate and a hinge shaft, the hinge shaft being fixed to the hinge plate by welding or other manners. During actual mounting, the hinge plate may be fixed to the box body 500 using bolts or other structures, and the box door 110 may be provided with threaded holes in advance. After the hinge plate is fixed to the box body 500, the hinge shaft may be inserted into the hinge hole of the box door 110, achieving a rotatable connection between the box door 110 and the box body 500.

In the traction assembly 310, the first rotate shaft fixation base 312 is provided at the slide door assembly 320, and the second rotate shaft fixation base 313 is provided at the hinge plate. Two ends of the traction rod 311 are rotatably connected to the first rotate shaft fixation base 312 and the second rotate shaft fixation base 313, respectively.

In actual use, in case that the box door 110 rotates relative to the box body 500 between the positions of opening and closing the storage space, the traction assembly 310 may pull the slide door assembly 320 to move, enabling the slide door assembly 320 to drive the cupboard door 200 to move relative to the box door 110 in the width direction of the box door 110.

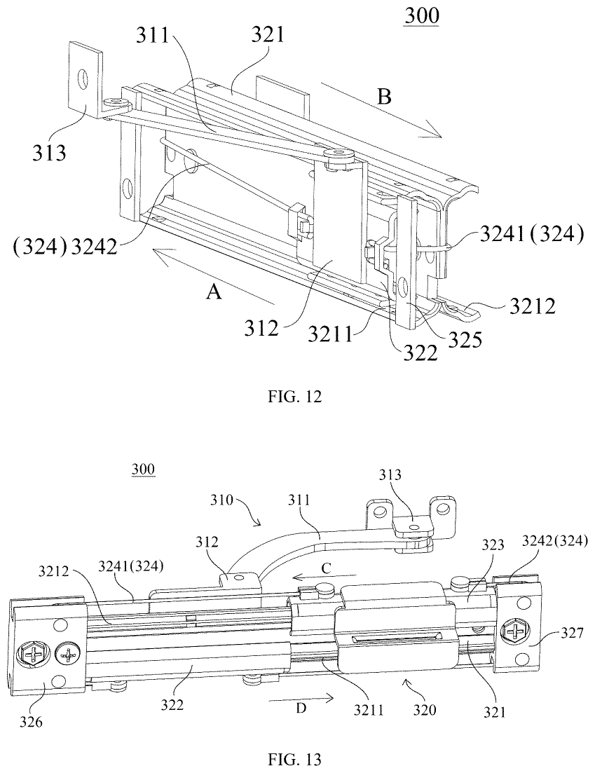

In an embodiment, to enable the slide door assembly 320 to effectively drive the cupboard door 200 to move relative to the box door 110 under the drive of the traction assembly 310, as shown in FIG. 11 and FIG. 12, the slide door assembly 320 includes: a base 321, a first slider 322, a second slider 323 and a connector 324.

A first guide rail 3211 is formed at a side of the base 321, and a second guide rail 3212 is formed at another side of the base 321. The first slider 322 is slidably provided at the first guide rail 3211. The first rotate shaft fixation base 312 is connected to the first slider 322. The second slider 323 is slidably provided at the second guide rail 3212 and is connected to the cupboard door 200. Two ends of the connector 324 are connected to the first slider 322 and the second slider 323, respectively.

During the process of opening or closing the box door 110, the traction rod 311 drives the first slider 322 to move at the first guide rail 3211, and the first slider 322 drives, through the connector 324, the second slider 323 to move in an opposite direction at the second guide rail 3212.

For example, the base 321 is provided with the first guide rail 3211 and the second guide rail 3212 arranged side by side and spaced apart. The first slider 322 is provided at the first guide rail 3211 and may slide along a length direction of the first guide rail 3211. The second slider 323 is provided at the second guide rail 3212 and may slide along a length direction of the second guide rail 3212. In addition, the first slider 322 and the second slider 323 are connected by the connector 324. In case that the first slider 322 moves at the first guide rail 3211, the first slider 322 may pull, through the connector 324, the second slider 323 to move at the second guide rail 3212. A movement direction of the second slider 323 is opposite to a movement direction of the first slider 322.

In an embodiment, as shown in FIG. 11 and FIG. 12, two opposite sides of the base 321 in a thickness direction are respectively a first side and a second side. U-shaped grooves are formed at the first side and the second side, respectively. A U-shaped groove at the first side is the first guide rail 3211, and a U-shaped groove at the second side is the second guide rail 3212. The first guide rail 3211 and the second guide rail 3212 extend along a length direction of the base 321. The first slider 322 is slidably provided in the first guide rail 3211, and the second slider 323 is slidably provided in the second guide rail 3212. In addition, the first rotate shaft fixation base 312 is connected to the first slider 322, and the cupboard door 200 may be fixedly connected to the second slider 323.

Taking into account practical application needs, limit structures may be provided at two ends of the first guide rail 3211 and the second guide rail 3212. Through limitation of the limit structure, the first slider 322 and the second slider 323 may move within a set moving range, and a moving distance may be set according to demand to meet use requirements of different occasions.

In an embodiment, the traction rod 311 is constructed as a long straight rod. An end of the traction rod 311 is rotatably connected to the first rotate shaft fixation base 312 through a first rotate shaft, and another end of the traction rod 311 is rotatably connected to the second rotate shaft fixation base 313 through a second rotate shaft. The second rotate shaft fixation base 313 is fixedly connected to the first slider 322.

In an embodiment, as shown in FIG. 12, the first rotate shaft fixation base 312 includes a first vertical plate and a first horizontal plate. The first vertical plate and the first horizontal plate are connected to each other to form an L-shaped structure. The first horizontal plate is provided with an axis hole, in which the first rotate shaft is inserted. A first end of the traction rod 311 is rotatably connected to the first rotate shaft, and is fixedly connected to the first rotate shaft fixation base 312. The first vertical plate may be fixedly connected to the first slider 322 by welding or other manners.

Similarly, as shown in FIG. 11 and FIG. 12, the second rotate shaft fixation base 313 includes a second vertical plate and a second horizontal plate. The second vertical plate and the second horizontal plate are connected to each other to form an L-shaped structure. The second horizontal plate is provided with an axis hole, in which the second rotate shaft may be inserted. A second end of the traction rod 311 is rotatably connected to the second rotate shaft, and is rotatably connected to the second rotate shaft fixation base 313.

To ensure that the first slider 322 and the second slider 323 may move synchronously in opposite directions, for example, the connector 324 includes a first connector 3241 and a second connector 3242, the first connector 3241 and the second connector 3242 being configured as flexible ropes. Along the length direction of the base 321, the first connector 3241 passes around a first end of the base 321. Two ends of the first connector 3241 respectively enter the first guide rail 3211 and the second guide rail 3212 and respectively connect to the first slider 322 and the second slider 323. The second connector 3242 passes around a second end of the base 321. Two ends of the second connector 3242 respectively enter the first guide rail 3211 and the second guide rail 3212 and respectively connect to the first slider 322 and the second slider 323. The two ends of the first connector 3241 are connected to the two ends of the second connector 3242 through the first slider 322 and the second slider 323, forming a generally annular structure.

During actual mounting, after the hinge plate is fixed to the box body 500, the second rotate shaft fixation base 313 may be fixed to the hinge plate using bolts or other structures. For example, the second vertical plate in the second rotate shaft fixation base 313 is provided with a through-hole. During mounting, external bolts may be passed through the through-hole and connected to the hinge plate, fixing the second vertical plate to the hinge plate.

The base 321 may be fixed to the box door 110 using bolts or other structures. For example, two joint plates 325 are provided at two sides of the base 321 in the longitudinal direction. Each of the two joint plates 325 is provided with a through-hole. During mounting, external bolts may be passed through the through-holes in the two joint plates 325 and connected to the box door 110, fixing the base 321 to the box door 110.

The cupboard door 200 is then fixed to the second slider 323. For example, the cupboard door 200 may be fixedly connected to the second slider 323 by bolts or a snap-fit structure, or the like.

In actual use, as shown in FIG. 11 and FIG. 12, in case that the box door 110 moves relative to the box body 500 from a position of closing the storage space to a position of opening the storage space, the first rotate shaft fixation seat 312 is fixed to the box door 110 following a hinge base. During rotation of the box door 110, the first slider 322 moves at the first guide rail 3211 along direction A. Accordingly, the first slider 322 pulls, through the first connector 3241, the second slider 323 to move at the second guide rail 3212 along direction B. Since the base 321 is fixedly connected to the box door 110 and the second slider 323 is fixedly connected to the cupboard door 200, the cupboard door 200 moves relative to the box door 110 along direction B. Direction A is opposite to direction B, and both direction A and direction B are parallel to the width direction of the box door 110.

In case that the door 110 moves relative to the box body 500 from a position of opening the storage space to a position of closing the storage space, during the rotation of the box door 110, the first slider 322 moves at the first guide rail 3211 in a direction opposite to direction A. Accordingly, the first slider 322 pulls, through the second connector 3242, the second slider 323 to move at the second guide rail 3212 in a direction opposite to direction B. In this case, the cupboard door 200 moves relative to the box door 110 in a direction opposite to direction B.

In an embodiment, as shown in FIG. 13 to FIG. 15, the base 321 is constructed as a plate-shaped structure having a certain length. The first guide rail 3211 and the second guide rail 3212 are respectively provided at both sides of the base 321 in the width direction. Both the first guide rail 3211 and the second guide rail 3212 extend along the length direction of the base 321. The first slider 322 is slidably provided at the first guide rail 3211, and the second slider 323 is slidably provided at the second guide rail 3212.

In some embodiments, the traction assembly includes: a first connect rod and a second connect rod. A first end of the first connect rod is rotatably provided at the hinge 400, for example, at the hinge plate of the hinge 400.

The first end of the first connect rod is rotatably provided at a mount area. For example, the first end of the first connect rod is mounted in the mount area through a rotate shaft fixation base. A first end of the second connect rod is rotatably connected to a second end of the first connect rod. A second end of the second connect rod is rotatably provided at the box door 110, and meshes with a teeth portion at the first slider 322 through a gear provided at the second end of the second connect rod.

The first connect rod and the second connect rod are connected by a hinge, and the first connect rod and the second connect rod are rotatable relative to each other. The first connect rod may rotate relative to the box body 500, and the second connect rod may rotate relative to the box door 110.

In case that the second end of the second connect rod moves with the box door 110 in a circular motion with the hinge shaft as a center, a distance between the second end of the second connect rod and the first end of the first connect rod changes due to an offset arrangement of the first end of the first connect rod and the hinge shaft, while a position of the second end of the second connect rod relative to the box door 110 remains unchanged. This causes the second end of the second connect rod to rotate about the box door 110, driving the second slider 323 to move the cupboard door 200 along the width direction of the box door 110.

In actual application, during the process of opening the box door 110, the box door 110 drives the second end of the second connect rod to rotate relative to the hinge shaft. Due to the offset arrangement of the first end of the first connect rod and the hinge shaft, a distance between the first end of the first connect rod and the second end of the second connect rod increases, driving the second end of the second connect rod to rotate clockwise relative to the box door 110, and controlling the second slider 323 to drive the cupboard door 200 to move along the width direction of the box door 110 in a direction away from the hinge 400, that is, to move to the left relative to the box door 110, which may avoid interference between the cupboard door 200 and a cupboard door 200 of a side cupboard body. During the process of closing the box door 110, the box door 110 drives the second end of the second connect rod to rotate relative to the hinge shaft. Due to the offset arrangement of the first end of the first connect rod and the hinge shaft, the distance between the first end of the first connect rod and the second end of the second connect rod decreases, driving the second end of the second connect rod to rotate counterclockwise relative to the box door 110, and controlling the second slider 323 to move the cupboard door 200 along the width direction of the box door 110 toward the hinge 400, that is, to the right relative to the box door 110, which may ensure that when closing the box door 110, the cupboard door 200 may avoid a cupboard door 200 of a side cupboard body and return to its original position.

In an embodiment, the first rotate shaft fixation base 312 is connected to the first slider 322, and the cupboard door 200 may be fixedly connected to the second slider 323. The first guide rail and the second guide rail serve as a kind of track, and the first slider 322 and the second slider 323 are slide members adapted to and slidable along the corresponding guide rails. In addition, the slide engagement between the first slider 322 and the first guide rail should at least include a situation where a ball is provided between the first slider 322 and the first guide rail, and the slide engagement between the second slider 323 and the second guide rail should at least include a situation where a ball is provided between the second slider 323 and the second guide rail.

Accordingly, the traction rod 311 may be constructed as an arc-shaped rod. An end of the traction rod 311 is rotatably connected to the first rotate shaft fixation base 312 through the first rotate shaft, and another end of the traction rod 311 is rotatably connected to the second rotate shaft fixation base 313 through the second rotate shaft.

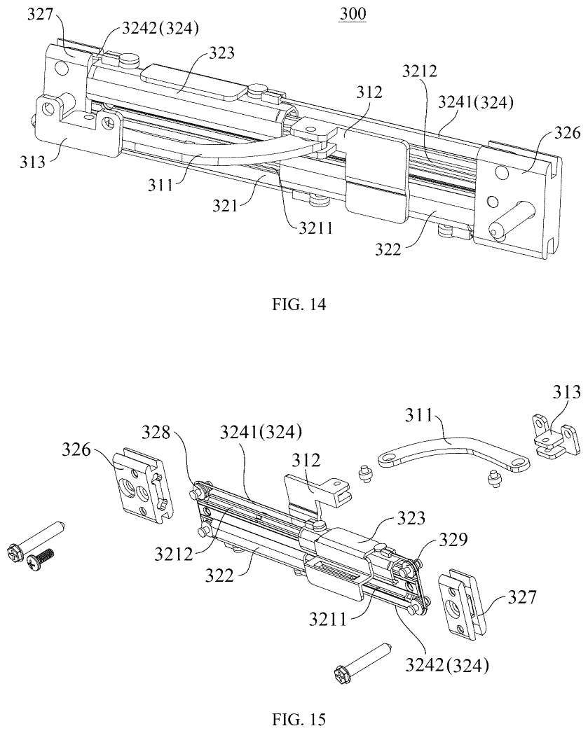

In an embodiment, as shown in FIG. 14 and FIG. 15, the first rotate shaft fixation base 312 is provided with a first clamp portion. The first clamp portion includes two clamp plates spaced side by side. The two clamp plates are respectively provided with a pin hole. The first rotate shaft is inserted into the two pin holes simultaneously. A first end of the traction rod 311 may be placed between the two clamp plates. An end portion of the traction rod 311 is rotatably connected to the first rotate shaft. As such, the traction rod 311 may be rotatably connected to the first rotate shaft fixation base 312. The first rotate shaft fixation base 312 may be fixedly connected to the first slider 322 by welding or other manners.

Similarly, as shown in FIG. 13 and FIG. 15, the second rotate shaft fixation base 313 is provided with a second clamp portion. The second clamp portion also includes two clamp plates spaced side by side. The two clamp plates are respectively provided with a pin hole. The second rotate shaft is inserted into the two pin holes simultaneously. A second end of the traction rod 311 may be placed between the two clamp plates. An end portion of the traction rod 311 is rotatably connected to the second rotate shaft. As such, the traction rod 311 may be rotatably connected to the second rotate shaft fixation base 313.

The first slider 322 and the second slider 323 are connected to each other through a connector 324. During movement, the first slider 322 may drive the second slider 323 to move in the opposite direction through the connector 324.

During actual mounting, after the hinge plate is fixedly mounted at the box body 500, the second rotate shaft fixation base 313 may be fixed to the hinge plate using bolts or other structures. For example, the second rotate shaft fixation base 313 is provided with a through-hole. During mounting, an external bolt may be passed through the through-hole and connected to the hinge plate, fixing the second rotate shaft fixation base 313 to the hinge plate.

The base 321 may then be fixed to the box door 110 using bolts or other structures. For example, a first receive plate 326 and a second receive plate 327 are respectively provided at two sides of the base 321 in the longitudinal direction. The first receive plate 326 and the second receive plate 327 are respectively provided with a through-hole. During mounting, an external bolt may be passed through the through-holes of the first receive plate 326 and the second receive plate 327 and connected to the box door 110, fixing the base 321 to the box door 110.

The cupboard door 200 is then fixed to the second slider 323. For example, the cupboard door 200 may be fixed to the second slider 323 using bolts or a snap-fit structure.

In actual use, as shown in FIG. 13 and FIG. 14, in case that the box door 110 moves relative to the box body 500 from a position of closing the storage space to a position of opening the storage space, the first rotate shaft fixation base 312 is fixed to the box door 110 following the hinge base, which causes, during the rotation of the box door 110, the first slider 322 to move at the first guide rail 3211 along direction C. Accordingly, the first slider 322 pulls, through the connector 324, the second slider 323 to move at the second guide rail 3212 along direction D. Since the base 321 is fixedly connected to the box door 110 and the second slider 323 is fixedly connected to the cupboard door 200, the cupboard door 200 moves relative to the box door 110 along direction D. Direction C is opposite to direction D, and both direction C and direction D are parallel to the width direction of the box door 110.

In case that the box door 110 moves relative to the box body 500 from a position of opening the storage space to a position of closing the storage space, during the rotation of the box door 110, the first slider 322 moves at the first guide rail 3211 in a direction opposite to direction C. Accordingly, the first slider 322 pulls, through the connector 324, the second slider 323 to move at the second guide rail 3212 along a direction opposite to direction D. In this case, the cupboard door 200 moves relative to the box door 110 in a direction opposite to direction D.

In an embodiment, to ensure that the first slider 322 may effectively drive the second slider 323 to move in the opposite direction, as shown in FIG. 13 to FIG. 15, the connector 324 includes a first connector 3241 and a second connector 3242.

The first connector 3241 passes around a first end of the base 321. Two ends of the first connector 3241 are respectively connected to a first end of the first slider 322 and a first end of the second slider 323. The second connector 3242 passes around a second end of the base 321. Two ends of the second connector 3242 are respectively connected to a second end of the first slider 322 and a second end of the second slider 323.

For example, the first connector 3241 may be a flexible rope. Along the length direction of the base 321, an end of the first connector 3241 is connected to the first slider 322. Another end of the first connector 3241, after passing around an end portion of the base 321, is connected to the second slider 323. That is, along the length direction of the base 321, the first connector 3241 passes around an end of the base 321, two ends of the first connector 3241 respectively extend toward the first slider 322 and the second slider 323, and the two ends of the first connector 3241 are respectively connected to the first slider 322 and the second slider 323.

Accordingly, an end of the second connector 3242 is connected to the first slider 322. Another end of the second connector 3242, after passing around another end portion of the base 321, is connected to the second slider 323. That is, along the length direction of the base 321, the second connector 3242 passes around the second end of the base 321, and two ends of the second connector 3242 are respectively connected to the first slider 322 and the second slider 323.

In this case, the two ends of the first connector 3241 are connected to the two ends of the second connector 3242 through the first slider 322 and the second slider 323, respectively, forming a generally annular structure.

For example, to ensure that the first connector 3241 and the second connector 3242 may properly pull the second slider 323 to move, as shown in FIG. 15, a first roller 328 and a second roller 329 are respectively provided at two sides of the base 321 in the longitudinal direction. The first roller 328 and the second roller 329 may respectively support the first connector 3241 and the second connector 3242.

As shown in FIG. 15, a number of the first roller 328 two, and the two first rollers 328 space apart along the width direction of the base 321. In addition, the two first rollers 328 may be rotatably provided at the first receive plate 326. To facilitate receiving the first connector 3241, an outer periphery of the first roller 328 may be provided with a receive groove along its circumference. As such, in case of mounting the first connector 3241, the first connector 3241 may be placed within the receive grooves of the two first rollers 328. In case that the first slider 322 pulls the second slider 323 through the first connector 3241, the first connector 3241 may drive the two first rollers 328 to rotate.

Similarly, a number of the second roller 329 is two, the two second rollers 329 space apart along the width direction of the base 321. In addition, the two second rollers 329 may be rotatably provided at the second receive plate 327. To facilitate receiving the second connector 3242, an outer periphery of the second roller 329 may also be provided with a receive groove along its circumference. As such, in case of mounting the second connector 3242, the second connector 3242 may be placed within the receive grooves of the two second rollers 329. In case that the first slider 322 pulls the second slider 323 through the second connector 3242, the second connector 3242 may drive the two second rollers 329 to rotate.

In the above-described arrangement, the first roller 328 may support and limit the first connector 3241, and the second roller 329 may support and limit the second connector 3242. The first roller 328 and the second roller 329 may prevent the first connector 3241 and the second connector 3242 from contacting other components during movement, which causes wear and tear, and may effectively protect the first connector 3241 and the second connector 3242.

As described above, an embodiment further provides a refrigeration apparatus, and the refrigeration apparatus includes a box body 500 and the door body device described in the above-described embodiments. The box body 500 is formed with a storage space, and the box door 110 is rotatably connected to the box body 500 through a hinge 400, and is configured to open or close the storage space of the box body 500.

It should be noted that the terms “parallel” and “perpendicular” in the embodiments of the present application should not be strictly limited to the geometric sense. At least manufacturing and installation errors should be taken into account. For example, an error of plus or minus 10° should be within the protection scope of the embodiments of the present application. In addition, the above embodiments are only used to illustrate the solutions of the present application, rather than to limit them. Although the present application is described in detail with reference to the aforementioned embodiments, those skilled in the art should understand that they can still modify the solutions described in the aforementioned embodiments, or make equivalent substitutions for some of the features therein. However, these modifications or substitutions do not cause the essence of the corresponding solutions to deviate from the scope of the solutions of the embodiments of the present application.

1. A door body device, used for a refrigeration apparatus comprising a box body, comprising:
a box door, wherein the box door is rotatably connected to the box body through a hinge and configured to open or close a storage space of the box body, and a thickness of the box door is 18 mm to 60 mm;
a cupboard door, wherein the cupboard door is slidably provided at an outside of the box door, and a thickness of the cupboard door is 12 mm to 26 mm; and
a slide door mechanism, wherein the slide door mechanism comprises a traction assembly and a slide door assembly connected to each other, the traction assembly being provided at the hinge, and the slide door assembly being provided at the box door and connected to the cupboard door; the traction assembly being configured to drive the slide door assembly to move during a process of opening or closing the box door, to drive the cupboard door to move in a width direction relative to the box door.

2. The door body device of claim 1, wherein a number of the box door is plural, each of the box doors corresponding to at least one of the storage space; and
each of the box doors is rotatably connected to the box body through a plurality of the hinges, and at least one of the hinges corresponds to each of the box doors being provided with the traction assembly.

3. The door body device of claim 2, wherein the hinge comprises a first hinge, the first hinge being provided at a top wall of the body box; and/or a second hinge, the second hinge being provided at a front surface of the body box; and/or
a third hinge, the third hinge being provided at a front surface of the body box, the third hinge being located between the first hinge and the second hinge.

4. The door body device of claim 3, wherein the first hinge comprises a first hinge plate and a first hinge shaft, a portion of the first hinge plate covering the top wall of the box body and a remaining portion of the first hinge plate protruding from the top wall toward a corresponding box door, the first hinge shaft extending downward from the portion of the first hinge plate protruding from the top wall, a top of the corresponding box door being hinged to the first hinge shaft, and the traction assembly being provided at one of the first hinge plate or the first hinge shaft.

5. The door body device of claim 3, wherein the second hinge comprises a second hinge plate and a second hinge shaft, the second hinge plate comprising a support plate and an extension plate, the support plate being mounted at the front surface of the box body, the extension plate being connected to a side of the support plate away from the front of the box body, the support plate being provided at an angle to the extension plate, the second hinge shaft being provided at a top surface of the extension plate and extending upward, a bottom of a corresponding box door being hinged to the second hinge shaft, and the traction assembly being provided at one of the second hinge plate or the second hinge shaft.

6. The door body device of claim 3, wherein the third hinge comprises a second hinge plate, a third hinge shaft and a fourth hinge shaft, the second hinge plate comprising a mount plate and a connect plate, the mount plate being mounted at the front surface of the box body, the connect plate being connected to a side of the mount plate away from the front surface of the box body, the connect plate being provided at an angle to the mount plate, the connect plate being provided with a first side and a second side opposite to each other, the third hinge shaft being provided at the first side, a bottom of the corresponding box door being hinged to the third hinge shaft, the fourth hinge shaft being provided at the second side, a top of the corresponding box door being hinged to the fourth hinge shaft, and the third hinge being provided with at least one of the traction assembly.

7. The door body device of claim 6, wherein the third hinge is provided with one traction assembly, the traction assembly being provided at one of the mount plate, the connect plate, the third hinge shaft, the fourth hinge shaft; or
the third hinge is provided with two traction assemblies, both of the two traction assemblies being provided at one of the mount plate or the connect plates, or the two traction assemblies being provided at the third hinge shaft and the fourth hinge shaft, respectively; or
the third hinge is provided with two traction assemblies, one of the two traction assemblies being provided at one of the mount plate or the connect plate, another one of the two traction assemblies being provided at one of the third hinge shaft and the fourth hinge shaft.

8. The door body device claim 1, wherein the door body device and the box body are configured to be provided in a mount space formed between a first cupboard body and a second cupboard body; during the process of opening or closing the box door, the slide door mechanism is configured to drive the cupboard door to move a preset distance at the box door, to allow the cupboard door to avoid a side wall of the first cupboard body and a side wall of the second cupboard body; or
the door body device and the box body are configured to be provided in a cupboard body; during the process of opening or closing the box door, the slide door mechanism is configured to drive the cupboard door to move a preset distance at the box door, to allow the cupboard door to avoid a side wall of the cupboard.

9. The door body device of claim 1, wherein the hinge comprises a hinge plate and a hinge shaft provided at the hinge plate, the hinge plate being provided at the box body, and the box door being rotatably provided at the box body through the hinge shaft;
the traction assembly comprises a traction rod, a first rotate shaft fixation base, and a second rotate shaft fixation base,
the first rotate shaft fixation base being connected to the slide door assembly, the second rotate shaft fixation base being connected to the hinge plate, a first end of the traction rod being rotatably connected to the first rotate shaft fixation base, and a second end of the traction rod being rotatably connected to the second rotate shaft fixation base; and
during the process of opening or closing the box door, the traction rod drives the slide door assembly to move, to drive the cupboard door to move in the width direction relative to the box door.

10. The door body device of claim 1, wherein the slide door assembly comprises:
a base being formed with a first guide rail at a side and a second guide rail at another side;
a first slider being slidably provided at the first guide rail, the traction assembly being connected to the first slider;
a second slider being slidably provided at the second guide rail and connected to the cupboard door; and
a connector having two ends connected to the first slider and the second slider, respectively;
wherein during the process of opening or closing the box door, the traction assembly drives the first slider to move at the first guide rail, and the first slider drives, through the connector, the second slider to move in an opposite direction at the second guide rail.

11. The door body device of claim 10, wherein the connector comprises:
a first connector passing around a first end of the base and having two ends connected to a first end of the first slider and a first end of the second slider, respectively; and
a second connector passing around a second end of the base and having two ends connected to a second end of the first slider and a second end of the second slider, respectively.

12. A refrigeration apparatus, comprising:
a box body being formed with a storage space; and
the door body device of claim 1, wherein the box door is rotatably connected to the box body through the hinge and is configured to open or close the storage space of the box body.
